(19) United States
(12) Patent Application Publication
(10) Pub. No.: US 2005/0007785 A1
(43) Pub. Date: Jan. 13, 2005

(54) Light source device for illuminating microdisplay devices

(75) Inventor: Trond A. Jorgensen, Drammen (NO)

Correspondence Address: MERCHANT & GOULD PC, P.O. BOX 2903, MINNEAPOLIS, MN, 55402-0903, US

(73) Assignee: VISITECH AS, DRAMMEN (NO)

(21) Appl. No.: 10/615,675

(22) Filed: Jul. 8, 2003

(30) Foreign Application Priority Data
Jul. 8, 2003 (NO) 2003 3133

(51) Int. Cl. F21V 1/00; F21V 11/00

(52) U.S. Cl. 362/321

(57) ABSTRACT

A light source device for illuminating microdisplay devices, e.g. a DMD, LCOS, LCD, GLV, etc. comprises a housing having a specularly and/or diffusely light reflective interior surface and an exit aperture adapted to the shape and size of the microdisplay device, wherein the housing defines a cavity, at least one light emitting device mounted on or in wall(s) of the housing, for emitting light into the cavity, electrical power supply unit(s) and control electronic unit(s) for controlling the light emitting device(s). The device may also comprise an optical component in the cavity, e.g. a lens in the light path for obtaining even more output efficiency of the device.

This application regards a light source device for illuminating microdisplay devices such as Digital Micromirror Devices (DMD), transmissive Liquid Crystal Display (LCD), reflective LCDs such as Liquid Crystal on Silicon (LCoS), Grating Light Valve (GLV), etc.

Projection systems have been used for many years to project motion pictures and still photographs onto screens for viewing. More recently, presentations using multimedia projection systems have become common. In a typical operating mode, multimedia projection systems receive analog video signals from a personal computer (“PC”). The video signals may represent still, partial, or full-motion display images of a type rendered by the PC. The analog video signals are typically converted in the projection system into digital video signals, and the signals are electronically conditioned and processed to control an image-forming device, such as a liquid crystal display (“LCD”) or a digital micro-mirror device (“DMD”).

A popular type of multimedia projection system employs a broad spectrum light source and optical path components upstream and downstream of the image-forming device to project the image onto a display screen.

Significant effort has been invested into developing projectors producing bright, high-quality, colour images. However, the optical performance of conventional projectors is often less than satisfactory. For example, suitable projected image brightness is difficult to achieve, especially when using compact portable colour projectors in a well-lighted room. The projectors typically use high intensity arc lamps as their light source and then filter out all of the light except for blue, green, and red light, which are optically transported along three separate light paths or using some form of sequential colour modulator.

Because LCD displays have significant light attenuation and triple path colour light paths are heavy and bulky, portable multimedia projectors typically employ DMD displays in a single light path configuration.

Producing a projected colour image with this configuration typically requires projecting a frame sequential image through a sequential colour modulator such as a colour wheel to coordinate colour image data.

The use of a colour wheel implies relatively long sequences of each colour and may cause rainbow effect in the image. The rainbow effect is caused by light passing through the spinning colour wheel with colours flashing sequentially. Even at colour wheel speeds of 9000 rpm and six equal-sized colour segments on the wheel (R-G-B-R-G-B), as found in advanced current DLP engines, certain people can discern the individual R-G-B colours appearing to break up on screen with rapid eye movements and certain images.

Another application area for an improved light source is film exposure machines. The film industry has changed to ha higher degree of digital post-processing of film material for special effects and different kind of overlays. However, the cinematic projectors are still analogue and the material therefore needs to be transferred to “printfilm”. This process has until now been performed by a laser or CRT-based exposure machine, capable of exposing one frame of a “master” in 2-10 seconds. This process takes several days to complete and thousands of dollars of expensive intermediate film. This master has been contact-copied to the “printfilm” at high speed, introducing errors and additional cost.

Norwegian Patent Application 20022308 describes a full-frame exposure machine capable of exposing the printfilm directly in real-time, and saves tremendous time and cost for low-volume distributions. This machinery calls for a tight control of red green and blue components of the exposure light.

Previous film-exposure machines have been based on tungsten lamps which light-spectra has been split into red green and blue colour-bands which expose the corresponding complementary colours in the film-layers. The three light-channels are controlled by light-gates which are electro-mechanically adjusted in order to balance the colours and exposure level.

WO 02080136 regards a method and apparatus for driving LED light sources for a projection display and more particularly the circuitry to drive a LED light source employed in an optical pathway of such displays. One problem connected to using LEDs in such applications is to get a good integrated, uniform light beam. This publication solves this problem by leading the light from the LEDs through a light pipe integrator. This will cause optical loss, may introduce aberrations in the light beam and/or alignment problems, and leads to a relatively large-sized source. Further, this apparatus uses one power supply switched between different LEDs, and thus cannot drive several LEDs at the same time. This leads to less flexibility in use, since there is no way to mix light from the different LEDs to adjust the spectral characteristics of the emitted light.

U.S. Pat. No. 6,220,725 describes a light source using an integrating cavity utilising Light Emitting Diodes as light emitters. This light source is a linear source with an elongated light aperture for use in scanners etc. The LEDs are mounted in special LED modules and each module is controlled by a circuit board. The housing material is a thermally non-conductive material with a thermally and electrically conductive coating. Due to the arrangement with LED modules and circuit boards, this embodiment has little flexibility in use, and is not suitable for illuminating small objects and applications which demand separate control of different wavelengths of light. In this publication, it is emphasized that the aperture size should be relatively large, with the ratio of exit port area to total internal area larger than 4% which means that for illuminating small objects, condensing optics must be added.

An object of the present invention is to provide an illumination system that simplifies the light source assembly by utilizing (high—intensity) LEDs, lasers or other electronically controlled light emitting device to replace the conventional light sources. These light emitting devices have the inherent feature that they can be controlled electronically independently to balance the colours presented to the object of interest.

The object of the invention is achieved by means of the features in the patent claims.

The light source device according to the invention comprises a housing defining a cavity and with an exit aperture, at least one light emitting device mounted on or in walls of the housing for emitting light into the cavity, at least one electrical power supply unit and at least one control electronic unit for controlling the light emitting device(s).

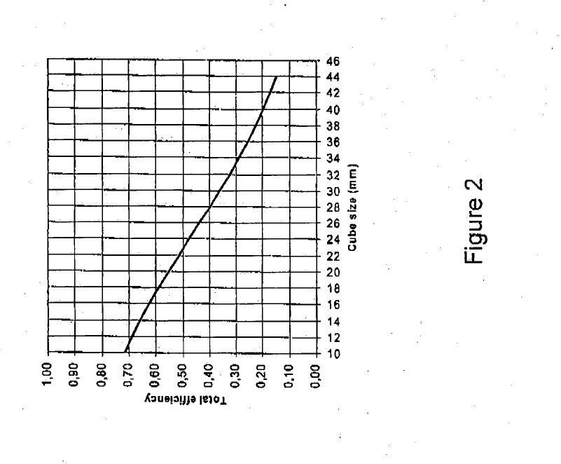

The housing, and thus the cavity, may have any suitable form, e.g. a cube, a sphere, a parallelepiped, any kind of polyhedron (regular or non-regular), a combination of any of those, or any other geometric form. The size and form of the housing, will together with the size of the exit aperture, affect the performance of the light source device, and should therefore be chosen according to the specific demands. In FIG. 2 the relationship between inner surface area of a cubic housing and total efficiency of the light source device is illustrated. The total efficiency will further increase with larger exit aperture, and the exit aperture/inner surface ratio should thus be chosen as high as practically possible. The form and size of the exit aperture will preferably be adapted to the object, which the light source device is meant to illuminate, e.g. a microdisplay such as DMD, LCOS, LCD, GLV, etc. For example, by use of a rectangular DMD, the exit aperture can have a rectangular form of substantially the same size as the DMD. The exit aperture may however be somewhat larger or smaller than the illumination object, depending on any optical components between the housing and the object to illuminate and/or the demands for efficiency, and similarly, the form may also deviate somewhat from the object, e.g. by using an elliptic or circular exit aperture to illuminate a square object.

The interior surface of the housing is highly reflective and diffusing, i.e. reflections from the interior surface will be diffuse (Lambertian) and/or partly specular (mirror). This can be achieved by producing the housing from a material with these properties or coating the interior surfaces with such a material. Examples of diffuse reflecting materials are BaSO₄ or Spectralon®. An example of a (partly) specular material is silver with dielectric coatings, but other materials or coatings are of course possible.

The reflective characteristics of the overall cavity will also depend on any components inside the cavity, such as the surface of the light emitting devices.

In some embodiments, the housing may be manufactured from a material with good thermal conductivity properties, e.g. a metal such as aluminium or other suitable material. The housing may also be connected to a cooling device for removing the heat generated in the light emitting devices. This will be particular important in applications which requires a large number of light emitting devices and/or light emitting devices with high light intensity which generates a lot of heat. The cooling device may be embedded in the housing, can be an external device or a combination of such. An example of a combinatory cooling system is cooling ribs integrated in the housing and an external fan blowing on the ribs. Other examples can be a fan, liquid cooling system comprising ducts embedded in the housing for cooling fluid, etc. It is an advantage if the connection between the light emitting devices and the housing has good thermal conductivity properties to “drain off” the heat generated in the light emitting devices. For monitoring and/or controlling the temperature of the housing, there may also be provided one or more temperature sensor(s) connected to the housing. The temperature sensor and/or the cooling system may be connected to the control unit for monitoring and/or controlling the temperature of the device.

As light emitting devices, is preferably at least one semiconductor source employed, such as Laser, LED, a combination of lasers and LEDs, etc. These devices have the advantage that they are highly controllable with respect to optical properties. Depending on the application, different numbers and combinations of light emitting devices and devices emitting different wavelengths can be employed to provide the desired light spectrum characteristics. For example, may LumiLEDs be employed for applications which demands high brightness. It is possible to use light emitting devices with different emitting areas/apertures, surface geometry and/or with varying spectral characteristics because of the excellent mixing of the light from the light emitting devices provided by the inventive device. This is very advantageous, as the spectral and angular characteristics of e.g. LEDs of same type may vary.

As an example, consider projector applications using DMD, where three different wavelength devices may be employed, e.g. LEDs emitting red (R), green (G) and blue (B). For modulating the colours on the DMD, the LEDs can be switched on and off in sequences, thus providing an RGB cycle onto the DMD. This makes the use of a colour wheel or other separate colour modulation devices, often with moving parts which are exposed to mechanical failure or irregularities, unnecessary. The time period of each sequence can be much shorter than in colour wheel applications, and this may reduce or even eliminate the rainbow effect. Compared to colour wheel applications, the invention also provides improved control of the colour sequencing. The time period for each colour in a sequence may be controlled in real time by changing it “on the fly” based on feedback control or user intervention. The order as well as the brightness of the colours/wavelengths in the sequence may also be varied in order to achieve adaptive and/or flexible sequencing of the wavelengths. In colour wheel devices, spoketime will occur in the sequencing. This is caused by the registration delay when the colour shifts, and may be reduced to near zero by means of the device according to the invention.

The light emitting devices may be mounted through the walls of the housing, emitting light into the cavity, and with the power supply lines and/or control signal lines connected outside the housing to power supply units and control signal units. Alternatively, the light emitting devices may be mounted on the inner walls of the housing, with power supply lines and/or control signal lines reaching out of the housing to external power supply units and control signal units.

When the light source device comprises more than one light emitting device, the light emitting devices may have separate power supply units (or current sources), or they may share one single power supply, in series or in parallel. Similarly, the light emitting devices may have separate control units, or they may share one single control unit. The control unit(s) are connected to the respective light emitting devices and/or to the power supply units, and may be adapted to adjust the emitted wavelengths, the emitted power, control on and off switching of the light, etc.

One possible configuration is to couple groups of light emitting devices in series, where each group is connected to a control unit and/or a power supply unit. In this way, the groups may be controlled individually, providing good control of the emitted light while enabling more light to be emitted with a small amount of electronics.

The possibility of individual driving of several light emitting devices or groups of light emitting devices, also enables simultaneous driving of different wavelengths for boosting white or secondary colours in the resulting image. This may enhance brightness.

It is of course possible to use any number of light emitting devices, and any available wavelength emitted from such devices. When combining devices emitting several different wavelengths, and using individual driving as described above, a general wavelength synthesizer can be obtained.

The light source device may additionally comprise other optical components inside or outside the cavity. One example is to arrange a collimating lens in the light path, i.e. in front of, or behind the exit aperture or any position inside the cavity. This will reduce the angular distribution of the light exiting the aperture, which makes it possible to use few, inexpensive and simple optical components, with higher F# after the light source devices. This will result in less aberration while still achieving equally good optical properties. Another advantage when placing a collimating lens adjacent to the aperture inside the cavity, is that this will lead to a larger virtual exit aperture (the light beam inside will “see” a larger aperture), and thus increased optical efficiency due to higher ratio between cavity surface and virtual exit aperture area. Even more increased efficiency is obtained because incident light with large angles to the lens will be subject to total internal reflections (TIR), and thus returned back into the cavity.

The cavity may be closed, e.g. by means of a transparent window in front of or behind the aperture, by the earlier mentioned lens, etc. This prevents contaminations from entering the cavity through the aperture, and will prevent reduction of efficiency caused by such contaminations. To further conserve the interior of the housing (surface, LED's, lenses etc.), the housing may be filled with an inert atmosphere.

The light source device may also comprise one or more light sensor(s). The light sensor may be located near the aperture, or in another location looking into the cavity. The light sensor may e.g. be mounted on the inner wall of the housing or through the housing wall. The light sensor may detect light intensity, wavelength and/or other spectral characteristics of the light.

The light sensor may be connected to a regulating unit. The regulating unit then receives the detected values from the light sensor, compares them to reference values, and communicates with the control units for adjusting the spectral characteristics of the light emitting devices to obtain the desired output, such as photo sensitive material/film. The reference values may be pre-set in the calibrating unit, or may be dynamic variables received from an external system, e.g. from a system controlling the resulting image of a projection system etc.

The invention will now be described in more detail by means of examples with reference to the accompanying drawings.

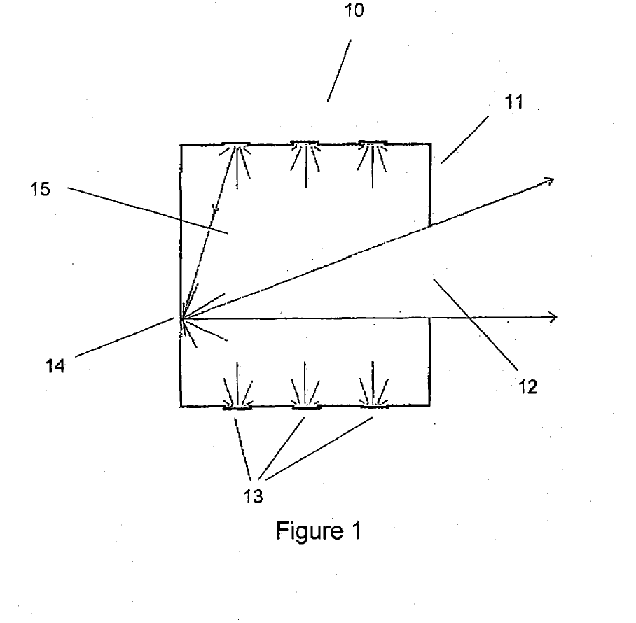

FIG. 1 shows the principle of the light source device according to the invention.

FIG. 2 shows a graph of total efficiency vs. cube size for a light source device according to the invention with cubic housing. The calculations are based on a housing without optical components inside.

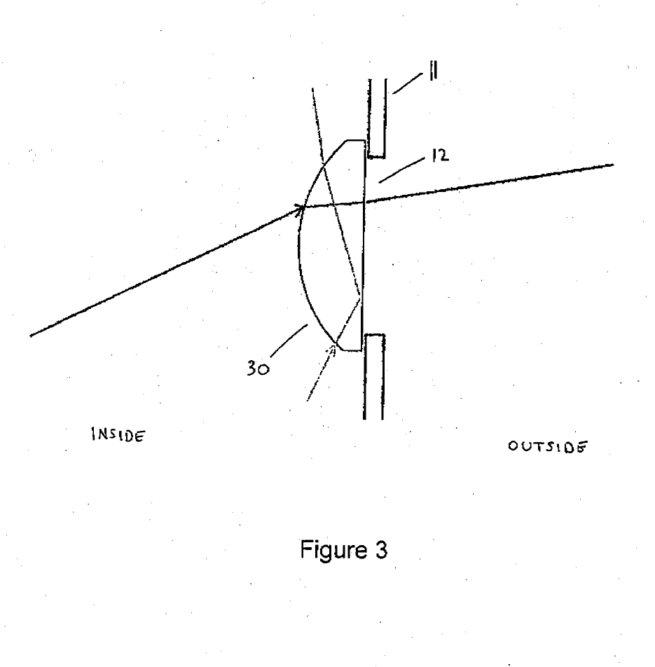

FIG. 3 shows the effect of the presence of a collimating lens in the light path inside the cavity.

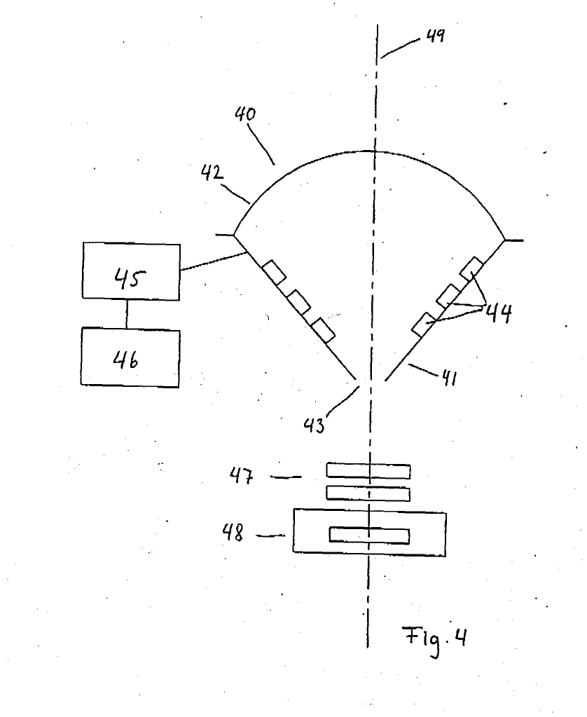

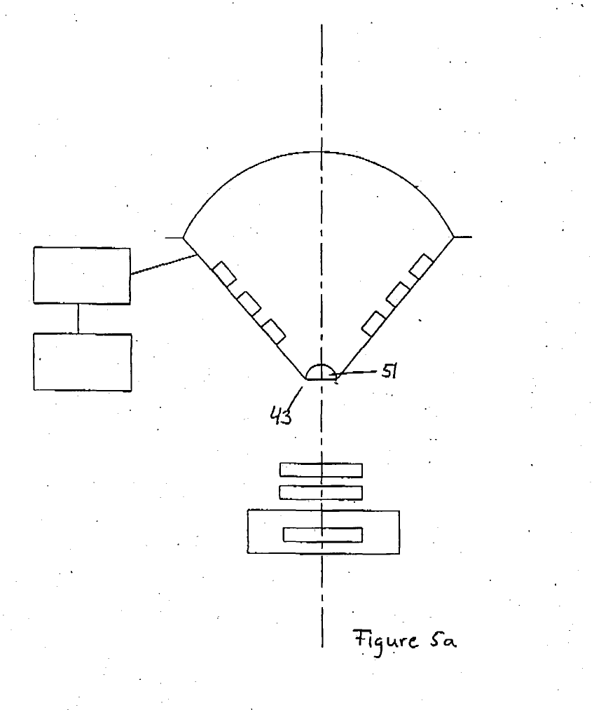

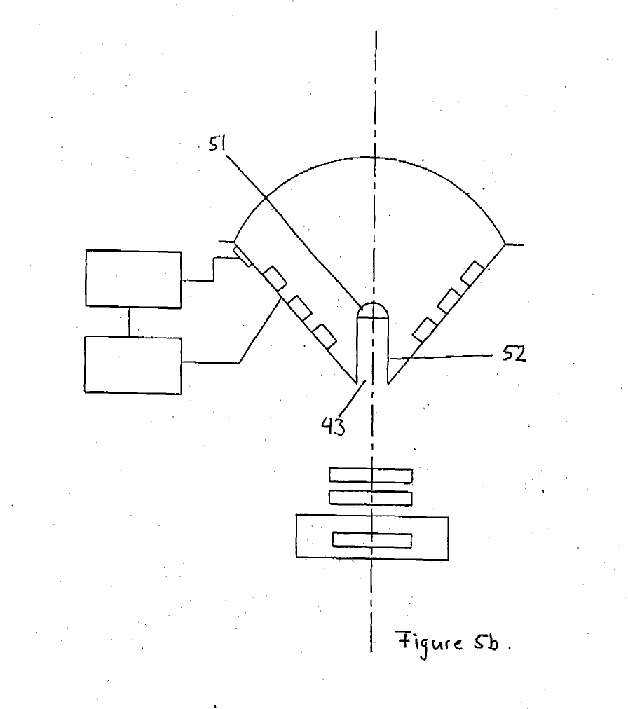

FIG. 4 shows one configuration of the invention and some other optical components for use in e.g. an imaging system.

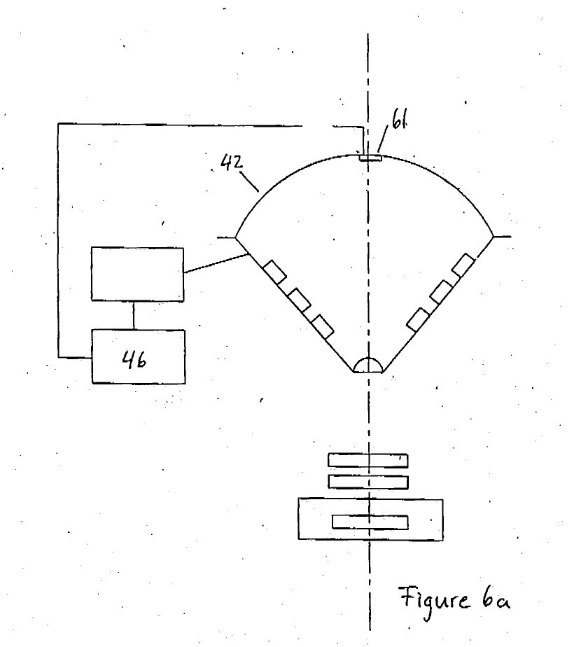

FIG. 5a and 5b show alternative embodiments of the invention according to FIG. 4 comprising an optical component inside the cavity.

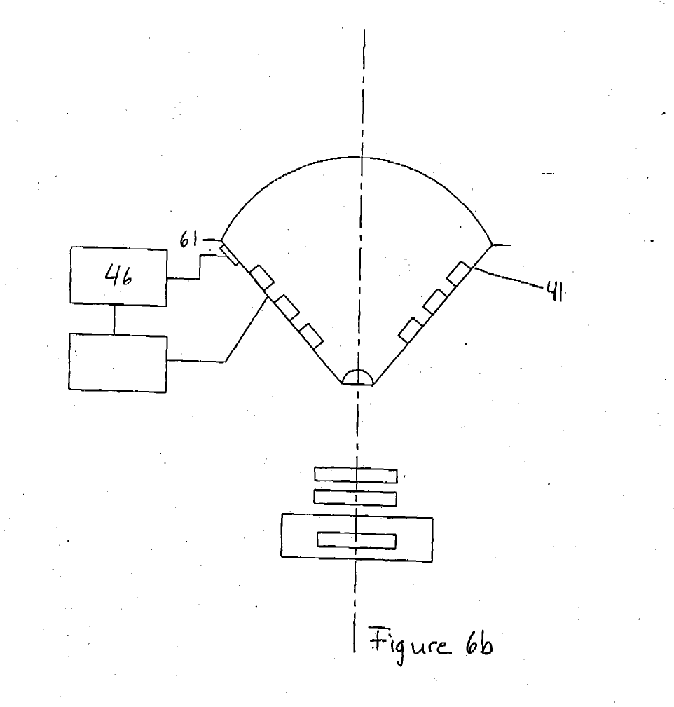

FIG. 6a and 6b show two embodiments of the invention comprising a light sensor in two alternative locations.

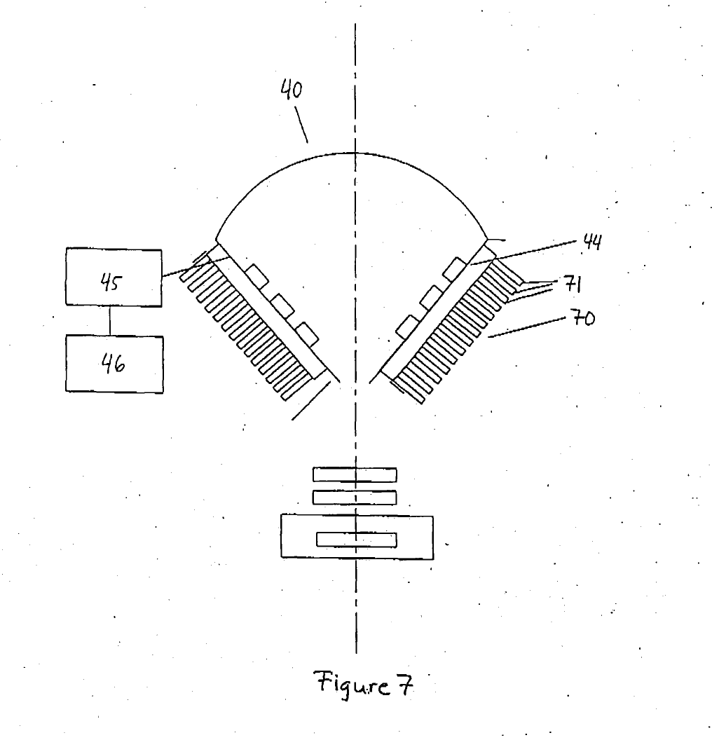

FIG. 7 shows an embodiment of the invention comprising a cooling system.

In FIG. 1 the light source device 10 according to the invention comprises a cubic housing 11 with an exit aperture 12. In this example the light source device 10 shows six light emitting devices 13, e.g. LED dies, located in two sidewalls. The light from the light emitting devices 13 emit light into the cavity 15. The inner walls of the cavity reflect the light non-specularly, illustrated by point 14. The amount of light escaping the exit aperture 12 depends on the area of the inner walls of the cavity 15. FIG. 2 show a graph of total efficiency vs. cube size for a light source device of the same type as in FIG. 1. The calculations are based on an assembly of 27 LumiLEDs optically coupled and integrated by the cavity to an exit aperture with size 10×7 mm and no optics inside the cavity. “Cube size” is internal length of one side of the housing. The cubic housing is coated internally with 99% diffuse reflective Spectralon® material. The reflectivity of LumiLED surface is assumed to be 95% specular. “Total efficiency” is the ratio of the light escaping the exit aperture to the light emitted from the light emitting devices. It can be seen that, for a fixed exit aperture, the total efficiency decreases with increasing cube size, and it is thus an advantage to keep the cube size as small as possible.

FIG. 3 is a closer view of the exit aperture 12 with a plano-convex lens 30 in the light path inside the cavity. The lens has several functions. Firstly, the lens will collimate the beam. This means that rays propagating towards the aperture with large incident angles, will be refracted and thus leave the aperture with less angle. In this way is less light “wasted”. Another effect is that rays with even larger incident angle will experience Total Internal Reflection (TIR) and thus be reflected back into the cavity. These light rays would otherwise have been “wasted”, or collimating optics would require lower F#.

In FIG. 4 the housing 40 has a conical section 41 with a semi-spherical closure 42 in the wide end of the cone and the exit aperture 43 in the tapered end of the cone. The light emitting devices 44 are arranged on the interior walls of the cone 41 and are connected to a power supply unit 45 and a control unit 46. The light exiting the exit aperture 43 propagates towards optional optical components 57 and a microdisplay device 48 which may be a part of an imaging system.

In FIG. 5a and 5b, the embodiment of the invention according to FIG. 4 comprises an optical component 51 inside the cavity in the exit aperture. This optical component may e.g. be a collimating lens of the kind described in connection with FIG. 3. In FIG. 5a, the lens 51 is positioned in/directly in front of the exit aperture 43. In this position, the lens 51 may be connected to the housing 40 in such a way that the lens closes the housing to protect the inside of the cavity/housing from contaminations. In FIG. 5b, the lens 51 is positioned inside the cavity formed by the housing 40, with a distance to the exit aperture. The lens 51 is supported by a support device 52 which may be connected closely to the edges of the exit aperture 43 to provide a closed cavity. The support device may also be connected to the cavity in any other location, e.g. when closing the cavity is not an important issue, or when the cavity is closed by other components.

FIG. 6a and 6b show the embodiment of FIG. 5 additionally comprising a light sensor 61 in two alternative locations. The light sensor is connected to the control unit 46. In FIG. 6a, the light sensor is placed inside the semi-spherical closure 42 along the central axis of the cone. In this location, the light sensor is located along the light emitting axis of the light source device.

In FIG. 6b, the light sensor is placed outside in the conical section 41, looking into the cavity through a pin hole in the wall.

FIG. 7 shows an embodiment of the invention comprising a cooling system 70. Preferably, the light emitting devices has good thermal contact to the housing. The cooling system consists of ribs 71 connected to the outer walls of the housing 40. The housing is preferably made of a highly thermal conductive material and the connection between the housing and the cooling ribs 71 should also be a thermal conductive connection. For further cooling efficiency, there may be provided a fan blowing air into the cooling ribs to transport the heat.

1. Light source device for illuminating microdisplay devices, e.g. a DMD, LCOS, LCD, GLV, etc, characterised in that it comprises
a housing having a specularly and/or diffusely light reflective interior surface and an exit aperture adapted to the shape and size of the microdisplay device, wherein the housing defines a cavity,
at least one light emitting device mounted on or in wall(s) of the housing, for emitting light into the cavity,
electrical power supply unit(s) and control electronic unit(s) for controlling the light emitting device(s).

2. Device according to claim 1, characterised in that it comprises at least two light emitting devices with separate power supply units.

3. Device according to claim 1, characterised in that it comprises at least two light emitting devices supplied with electricity from a single power supply.

4. Device according to claim 1, 2 or 3, characterised in that the at least two light emitting devices are adapted for emitting light with different wavelengths.

5. Device according to claim 4, characterised in that the control unit is adapted to control on and off switching of the light emitting in sequences.

6. Device according to claim 4, characterised in that the control unit is adapted to adjust the wavelength and brightness/intensity of the light emitted from the exit aperture by individual control of the light emitting devices or groups of light emitting devices.

7. Device according to claim 5, characterised in that the light emitting devices are adapted to emit red (R), green (G) and blue (B) light, and that the control unit is adapted to switch said devices on and off to provide cycles of said colours to the microdisplay device.

8. Device according to claim 1, characterised in that it comprises optical components inside the cavity.

9. Device according to claim 1, characterised in that it comprises a lens in the light path, preferably inside the cavity.

10. Device according to claim 1, 7 or 8, characterised in that it comprises a transparent window or lens for closing the aperture in order to provide a closed, contamination free cavity.

11. Device according to claim 1, characterised in that it also comprises a light sensor.

12. Device according to claim 10, characterised in that the light sensor is connected to a control electronic unit to adjust the optical characteristics of the light sources.

13. Device according to claim 1, characterised in that the housing is made of a material with good thermal conductivity properties.

14. Device according to any of the claims 1-12, characterised in that it comprises a cooling system.

15. Device according to claim 13, characterised in that the cooling system is completely or partly embedded in the housing.

16. Device according to one of the claims 1-14 characterised in that it comprises a temperature sensor.

17. Device according to claim 15, characterised in that the temperature sensor and/or the cooling system is connected to the control electronic unit.

18. Device according to one of the claims 1-16, characterised in that it comprises imaging and/or integrating optics in the light path outside the housing, from exit aperture to micro display.
